(19) United States
(12) Patent Application Publication
(10) Pub. No.: US 2016/0141754 A1
(43) Pub. Date: May 19, 2016

(54) PHASED ARRAY ANTENNA

(71) Applicant: Fraunhofer-Gesellschaft zur Foerderung der angewandten Forschung e.V., Munich (DE)

(72) Inventors: Martin LEYH, Erlangen (DE); Mario SCHUEHLER, Marloffstein (DE); Michael SCHLICHT, Seligenporten (DE); Frank MAYER, Baiersdorf (DE)

(21) Appl. No.: 14/882,074

(22) Filed: Oct. 13, 2015

(30) Foreign Application Priority Data
Oct. 13, 2014 (EP) 14188667.1

(51) Int. Cl. H01Q 3/36; H01Q 13/00; H01Q 3/24

(52) U.S. Cl. CPC H01Q 3/36; H01Q 3/247; H01Q 13/00

(57) ABSTRACT

Embodiments provide a phased array antenna including a feed structure adapted to guide an electromagnetic wave, a plurality of controllable elements coupled to the feed structure and a plurality of radiating elements, wherein each of the radiating elements is coupled to at least two of the plurality of controllable elements.

### CROSS-REFERENCE TO RELATED APPLICATIONS

This application claims priority from European Patent Application No. 14188667.1, which was filed on Oct. 13, 2014, and is incorporated herein in its entirety by reference.

### BACKGROUND OF THE INVENTION

Embodiments relate to a phased array antenna. Further embodiments relate to a method for operating a phased array antenna. Some embodiments relate to a phased array with dedicated radiating elements.

To receive communication signals from or to transmit communication signals to a satellite, antennas with significant effective gain and directivity are necessitated. Effective gain (e.g. compared to a 0 dB omni-directional antenna) is needed to compensate for the propagation losses through free space and the atmosphere. Directivity (pointing) is necessitated to discriminate the wanted signal from other signals received or transmitted on the same frequency but from/to different orbital locations.

Besides satellite communications, the same technical problems exist also for many other communication systems, e.g. terrestrial, space or airborne, where in general high antenna gain improves the signal to noise ratio, while antenna directivity in the direction of propagation helps to mitigate (isolate from) eventually interfering signals from other sources.

Well known parabolic dish or horn antennas have their gain and directivity pattern mainly defined by geometry and by mechanical pointing. There are a number of applications where either the receiver or transmitter or both are moving, such as airborne, mobile satellite terminals, non-GEO satellite systems (GEO=geosynchronous Earth orbit). In these cases such an antenna arrangement would need to be continuously re-aligned to point towards the communication partner. This re-alignment (or tracking) can either be achieved by mechanical re-pointing of the antenna/reflector/horn etc. or by an electrically steerable arrangement, e.g. a well-known phased array antenna.

Phased array antennas are known long since and are in common use. However, due to their relatively high price (manufacturing costs, number and quality of components) and power consumption their application is limited to niche markets and applications, e.g. tracking receivers, military applications.

The basic principle behind a phased array is the use of several (up to several thousand) antenna elements that may be individually controlled, in phase and/or amplitude. Given the known arrangement of the antenna elements, it is possible to synthesize different directivity patterns by individually controlling the phase (and optionally the amplitude) of each element.

For instance, a simple phased array may be composed of a number of radiating elements, placed equidistantly in one row (linear phased array). Feeding each of these radiating elements along the row with an identical, but phase shifted signal results in additive and destructive addition of the radiated waves. If e.g. the distance of the radiating elements is set to one half of the wavelength λ and each element is feed with a signal with phase offset of λ/4, relative to the previous element in the row, coherent signal addition will occur at a tilt angle of 30° relative to zenith. Varying the phase offset between 0 and +/−λ/2 will lead to tilt angles between 0° (zenith) and +/−90°.

An example for a two-dimensional phased array 10 is shown in FIG. 1. The phased array 10 is composed of a feeding structure 12 that connects to a number of steerable elements 14. Each of these elements 14 transmits and/or receives a signal (wave) 16 with a defined phase and amplitude, pre-set to result in coherent signal addition along the direction of interest. In transmit mode, a high power amplifier amplifies and transmits the signal of interest (transmit signal) 18 into the feeding structure 12, using a splitter network 20; in receive mode, a low noise amplifier amplifies the signal received (receive signal) 22 and constructively combined in the combiner network 20. Note that splitter 20 and combiner 20 network may have the same physical structure, and serve as splitter 20 or combiner 20 depending on the direction of the signal propagation.

Various implementations for the phase shifter used in such a phased array are known. This includes, but is not limited to, switched delay lines, loaded lines, where the e.g. capacitive or inductive loads are varied to vary the propagation speed along the electrical line, or wave propagation through media with steerable propagation characteristics. The latter includes phase shifters based on materials with steerable permeability or permittivity.

From WO 2012/050614 A1 a surface scattering antenna is known that provides an adjustable radiation field by adjustably coupling scattering elements spaced at a distance of λ/4 or less along a wave-propagating structure. Adjusting (e.g. opening or closing) the scattering elements allows synthesis of different directivity patterns. More precisely, the pattern of open or closed scattering elements and their position and relative phase at this position (based on wave propagation in the wave-propagating medium) translates into a certain directivity pattern. Vice versa, a wanted directivity pattern may be synthesized by steering a suitable (e.g. open and closed) pattern at the scattering elements.

Also known from literature are wave-propagating structures that directly or indirectly couple waves (e.g. emitted through slots or holes in a waveguide used as the wave-propagating structure) into resonant elements (e.g. antenna patches covering, at a given distance, the waveguides slots or holes) [A. Krauss et al, “Low-Profile Ka-Band Satellite Terminal Antenna Based on a Dual-Band Partially Reflective Surface,” in Proc. of the 6th European Conference on Antennas and Propagation (EUCAP), Rome, Italy, 2011, pp. 2734 2738]. Such combined wave-propagating/radiating element structures are e.g. known to be used for additional (static) beam shaping or to form a pre-dominant polarization. Both effects are controlled by using a suitable geometry, size and shape of the radiating element and suitable coupling between wave-propagating structure and radiating element.

U.S. Pat. No. 3,386,092 shows a phased array radar system including a plurality of transmit-receive modules, each including a radiation element and capable of providing power amplification, phase shifting, mixing, frequency multiplication of a transmitted and/or received signal in the module.

U.S. Pat. No. 5,923,289 shows a modular phased array antenna for the formation of simultaneous independently steerable multiple beams, the modular phased array antenna comprising a modular array including a plurality of sub-array modules combined together in close proximity, each one of the plurality of sub-array modules including a plurality of input modules, a layer of a plurality of radiating antenna elements, a plurality of stacked beamformers arranged in series and each connected to one of the plurality of input modules and to the plurality of radiating antenna elements in beam communication.

U.S. Pat. No. 6,812,903 shows a radio frequency aperture comprising a plurality of insulating layers disposed in a stack, each layer including an array of conductive regions, the conductive regions being spaced from adjacent conductive regions.

U.S. Pat. No. 6,483,393 shows a method and two devices for obtaining phase shifts by using a non-reciprocal resonator supporting single-mode operation. As such, wave propagation in the resonator is unambiguous in phase, allowing the phase to be coupled in or out at different positions. This results in phase shifter devices of two kinds: One kind of the devices suggests to change the coupling positions by using switches, and the other kind suggests to use a movable port to be driven by a step motor, for example.

US 2003/067410 A1 shows a radiator including a waveguide having an aperture and a patch antenna disposed in the aperture. An antenna includes an array of waveguide antenna elements, each element having a cavity, and an array of patch antenna elements including an upper patch element and a lower patch element disposed in the cavity.

US 2004/164907 A1 a slot fed microstrip antenna provides improved efficiency through enhanced coupling of electromagnetic energy between the feed line and the slot. The dielectric layer between the feed line and the slot includes magnetic particles, the magnetic particles included in the dielectric junction region between the microstrip feed line and the slot.

U.S. Pat. No. 6,791,496 shows a slot fed microstrip antenna having a stub. A dielectric layer disposed between the feed line and the ground plane provides a first region having a first relative permittivity and at least a second region having a second relative permittivity. The second relative permittivity is higher as compared to the first relative permittivity. The stub is disposed on the high permittivity region. The dielectric layer can include magnetic particles, which are disposed underlying the stub.

US 2004/189528 A1 shows a slot fed microstrip patch antenna including a conducting ground plane, the conducting ground plane including at least one slot. A dielectric material is disposed between the ground plane and at least one feed line, wherein at least a portion of the dielectric layer includes magnetic particles. The dielectric layer between the feed line and the ground plane provides regions having high relative permittivity and low relative permittivity. At least a portion of the stub is disposed on the high relative permittivity region.

US 2004/227667 A1 shows an antenna having at least one main element and a plurality of parasitic elements. At least some of the elements have coupling elements or devices associated with them, the coupling elements or devices being tunable to thereby control the degree of coupling between adjacent elements. Controlling the degree of coupling allows a lobe associated with the antenna to be steered.

US 2008/048917 A1 shows techniques, apparatus and systems that use one or more composite left and right handed (CRLH) metamaterial structures in processing and handling electromagnetic wave signals. Antennas and antenna arrays based on enhanced CRLH metamaterial structures are configured to provide broadband resonances for various multi-band wireless communications.

US 2008/238795 A1 shows systems and methods for controlling beam direction of an array of antenna elements in a wireless communications system. Aperture control shutters substantially cover each radiating antenna element. Each aperture control shutter is selectively turned on or off to control the direction of a beam of the antenna array.

US 2010/156573 A1 shows metamaterials for surfaces and waveguides. Complementary metamaterial elements provide an effective permittivity and/or permeability for surface structures and/or waveguide structures. The complementary metamaterial resonant elements may include Babinet complements of “split ring resonator” (SRR) and “electric LC” (ELC) metamaterial elements. In some approaches, the complementary metamaterial elements are embedded in the bounding surfaces of planar waveguides, e.g. to implement waveguide based gradient index lenses for beam steering/focusing devices, antenna array feed structures, etc.

WO 2013/045267 A1 shows a two-dimensional beam steerable phased array antenna comprising a continuously electronically steerable material. Further, a compact antenna architecture including a patch antenna array, tunable phase shifters, a feed network and a bias network are proposed.

US 2013/249751 A1 shows a dynamically-reconfigurable feed network antenna having a microstrip patchwork radiating surface wherein individual radiating patches and elements of a stripline feed structure can be connected to and disconnected from each other via photoconductive interconnections. Commands from software alternately turn light from light emitting sources on or off, the light or lack thereof being channeled from an underside layer of the antenna so as to enable or disable the photoconductive interconnections. The resultant connection or disconnection of the radiating patches to each other and to the stripline feed structure will vary the antenna's frequency, bandwidth, and beam pointing.

U.S. Pat. No. 6,396,440 B shows a phased array antenna apparatus including a plurality of radiation elements, a power supply unit, a power distributor, a feed probe, a plurality of electromagnetic coupling units, and a plurality of phase shifters. The radiation elements are aligned and arranged to be electromagnetically driven. The power supply units supply power to the radiation elements. The power distributor has a pair of conductive plates arranged to be parallel to each other and acts as a radial waveguide distributing the power supplied from the power supply unit to the radiation elements. The feed probe is arranged on one of the conductive plates to radiate an electromagnetic wave into the radial waveguide in accordance with the power supplied from the power supply unit. The electromagnetic coupling units are arranged on the other conductive plate in correspondence with the radiation elements to extract the electromagnetic wave radiated from the feed probe and propagating through the radial waveguide by electromagnetic coupling. The phase shifters control a phase of the electromagnetic wave extracted by the electromagnetic coupling units and supply the electromagnetic wave to the radiation elements.

U.S. Pat. No. 5,512,906 A shows an array of antenna elements configured in a lattice-like layer, each element being similarly oriented such that the whole of the antenna elements form a homogeneous two-dimensional antenna aperture surface. The antenna elements are connected in a one-to-one correspondence to a matching lattice of mutually similar, multiple-port, wave coupling networks physically extending behind the antenna element array as a backplane of the antenna. Each wave coupling network or unit cell couples signals to and/or from its corresponding antenna element and further performs as a phase delay module in a two-dimensional signal distribution network.

U.S. Pat. No. 6,317,095 B shows a planar antenna including a planar ground conductor, a plurality of radiating dielectrics arranged in parallel and at established intervals on a surface of the ground conductor, and a plurality of perturbations for radiating an electromagnetic wave. The perturbations each have a given width and are arranged at established intervals on a top surface of each of the plurality of radiating dielectrics along a longitudinal direction thereof, and a feeding section is provided alongside one end of each of the plurality of radiating dielectrics for feeding an electromagnetic wave to respective lines formed by each of the radiating dielectrics and the ground conductor.

US 2008/258993 A shows an apparatus, systems and techniques for using composite left and right handed (CRLH) metamaterial (MTM) structure antenna elements and arrays to provide radiation pattern shaping and beam switching.

US 2013/271321 A relates to a method of electronically steering an antenna beam. Beam steering is accomplished by altering the electric-field distribution at the open-end of one or more overmoded waveguides through the controlled mixing of multiple modes. The method includes propagating a signal in multiple modes in a waveguide, and controlling the relative phase and amplitude of the respective modes, relative to each other, to steer the beam.

U.S. Pat. No. 4,150,382 A discloses a guided radio wave launched along an antenna surface having an array of elements which provide variable non-uniform surface impedance adapted to be controlled by electronic signals. Each variable impedance element may comprise a wave guide section having one end leading from the antenna surface. Each wave guide section may include a solid-state electronic reflection amplifier having characteristics which can be varied by supplying control signals to the amplifier, to vary the magnitude and phase angle of the wave reflected from the reflection amplifier. By changing the control signals supplied to any particular reflection amplifier, it is possible to cause attenuation or amplification and phase shift of the guided wave as it passes across the particular wave guide section.

### SUMMARY

According to a first embodiment, a phased array antenna may have: a feed structure adapted to guide an electromagnetic wave; a plurality of controllable elements coupled to the feed structure; and a plurality of radiating elements; wherein each of the radiating elements is coupled to at least two of the plurality of controllable elements.

According to another embodiment, a method for operating a phased array antenna, the phased array antenna including a feed structure adapted to guide an electromagnetic wave, a plurality of controllable elements coupled to the feed structure, and a plurality of radiating elements, wherein each of the radiating elements is coupled to at least two of the plurality of controllable elements may have the step of: transmitting or receiving a signal with the phased array antenna.

Embodiments provide a phased array antenna comprising a feed structure adapted to guide an electromagnetic wave, a plurality of controllable elements coupled to the feed structure and a plurality of radiating elements, wherein each of the radiating elements is coupled to at least two of the plurality of controllable elements.

According to the concept of the present invention, by coupling each of the radiating elements to at least two of the plurality of controllable elements, the original problem of finding a suitable phase (and optional amplitude) setting for each controllable element at the location of this controllable (and radiating) element (cf. FIG. 1) transforms into the problem of finding a suitable effective phase (and optional amplitude) setting for each group of controllable elements coupled to the respective radiating element of the plurality of radiating elements. Furthermore, additional flexibility with regard to the placement of the radiating elements and thus the location of each radiated wave is provided.

Further embodiments provide a method for operating a phased array antenna. The phased array antenna comprises a feed structure adapted to guide an electromagnetic wave, a plurality of controllable elements coupled to the feed structure, and a plurality of radiating elements, wherein each of the radiating elements is coupled to at least two of the plurality of controllable elements. The method comprises transmitting or receiving a signal with the phased array antenna.

### BRIEF DESCRIPTION OF THE DRAWINGS

Embodiments of the present invention will be detailed subsequently referring to the appended drawings, in which:

FIG. 1 shows an illustrative, perspective view of a common phased array antenna.

FIG. 2 shows a side-view of a phased array antenna according to an embodiment.

FIG. 3 shows an illustrative, perspective view of a phased array antenna according to an embodiment.

FIG. 4 shows an illustrative, perspective view of an implementation of the feed structure as waveguide with an aperture, according to an embodiment.

FIG. 5 shows an illustrative, perspective view of an implementation of the feed structure as waveguide with a plurality of apertures, according to an embodiment.

FIG. 6 shows an illustrative view of four different implementations of an aperture of the waveguide, according to an embodiment.

FIG. 7 shows an illustrative, perspective view of an implementation of the feed structure as periodically loaded transmission line in microstrip technique, according to an embodiment.

FIG. 8 shows an illustrative, perspective view of a two-dimensional arrangement of radiating elements, according to an embodiment.

FIG. 9a-9i show illustrative top-views of implementation examples for the radiating elements, according to embodiments.

FIG. 10 shows a flowchart of a method for operating a phased array antenna, according to an embodiment.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

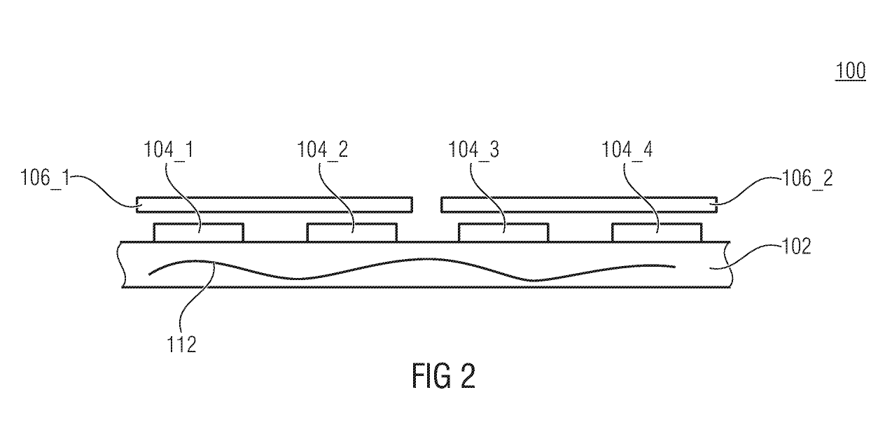

FIG. 2 shows a side-view of a phased array antenna 100 according to an embodiment. The phased array antenna 100 comprises a feed structure 102 adapted to guide an electromagnetic wave 112, a plurality of controllable (or steerable) elements 104_1 to 104_n coupled to the feed structure 102, and a plurality of radiating elements 106_1 to 106_m, wherein each of the radiating elements 106_1 to 106_m is (resonantly) coupled to at least two of the plurality of controllable elements 104_1 to 104_n.

In embodiments the phased array antenna 100 may comprise up to n controllable elements 104_1 to 104_n and up to m radiating elements 106_1 to 106_m, wherein n is a natural number equal to or greater than four, n≧4, and wherein m is a natural number equal to or greater than two, m≧2.

In FIG. 2, the phased array antenna 100 comprises by way of example four controllable elements 104_1 to 104_n (n=4) and two radiating elements 106_1 to 106_m (m=2). Thereby, a first radiating element 106_1 of the two radiating elements 106_1 to 106_m (m=2) is coupled to a first controllable element 104_1 and a second controllable element 104_2 of the four controllable elements 104_1 to 104_n (n=4), wherein a second radiating element 106_2 of the two radiating elements 106_1 to 106_m (m=2) is coupled to a third controllable element 104_3 and a fourth controllable element 104_4 of the four controllable elements 104_1 to 104_n (n=4).

The controllable elements 104_1 to 104_n can be adapted to couple energy between the feed structure 102 and the radiating elements 106_1 to 106_m. For example, when transmitting a signal with the phased array antenna 100, the controllable elements 104_1 to 104_n may couple energy from the feed structure 102 to the radiating elements 106_1 to 106_m. Further, when receiving a signal with the transmit antenna 100, the controllable elements 104_1 to 104_n may couple energy from the radiating elements 106_1 to 106_m to the feed structure 102.

As can be seen in FIG. 2, the plurality of controllable elements 104_1 to 104_n can be arranged between the feed structure 102 and the plurality of radiating elements 106_1 to 106_m. The feed structure 102, the plurality of controllable elements 104_1 to 104_n and the plurality of radiating elements 106_1 to 106_m can form stacked layers.

Further, as shown in FIG. 2, each of the radiating elements 106_1 to 106_m can be fed at at least two different positions via the at least two controllable elements 104_1 to 104_n. For example, the first radiating element 106_1 is fed at a first position via the first controllable element 104_1 and at a second position different from the first position via the second controllable element 104_2. Similarly, the second radiating element 106_2 is fed at a third position via the third controllable element 104_3 and at a fourth position different from the third position (and also different from the first and second positions) via the fourth controllable element 104_4.

Also the plurality of controllable elements 104_1 to 104_n can be fed by the feed structure 102 at different positions. For example, the first controllable element 104_1 is fed by the feed structure 102 at a first position, wherein the second controllable element 104_2 is fed by the feed structure 102 at a second position different from the first position. As indicated in FIG. 2, the same may apply to the third and fourth controllable elements 104_3 and 104_4.

As already mentioned, each of the radiating elements 106_1 to 106_m is coupled to at least two of the plurality of controllable elements 104_1 to 104_n. Thereby, each of the at least two controllable elements can be adapted to individually adjust its degree of coupling to the respective radiating element. Thus, a degree of coupling between the first controllable element 104_1 and the first radiating element 106_1 may be adjusted to a first value (e.g., between 0% and 100%), wherein the degree of coupling between the second controllable element 104_2 and the first radiating element 106_1 may be set independent from the first value to a second value (e.g., between 0% and 100%). Thereby, the first value and the second value may differ from each other or be equal to each other. For example, the degree of coupling between the first controllable element 104_1 and the first radiating element 106_1 may be set to 20% (or 0%, 10%, 30%, 40%, 50% 60%, 70%, 80%, 90% or 100%), wherein the degree of coupling between the second controllable element 104_2 and the first radiating element 106_1 may be set to 70% (or 0%, 10%, 20% 30%, 40%, 50% 60%, 80%, 90% or 100%).

In other words, the number of steerable elements 104_1 to 104_n connected to each radiating element 106_1 to 106_m may be varied, e.g. by concurrent weighted/switched connections of more than one controllable element 104_1 to 104_n to an radiating element. For example, more than one of the at least two controllable elements feeding a radiating element may be active at the same time. Further, more than one of the at least two controllable elements feeding a radiating element may be combined in a weighted or switched (on/off) fashion.

In embodiments, the feed structure 102 can comprise a waveguide. Thereby, the plurality of controllable elements 104_1 to 104_n can be arranged between coupling points of the waveguide 102 and the radiating elements 106_1 to 106_m.

The controllable elements 104_1 to 104_n can comprise independently controllable phase shifter elements arranged between the coupling points of the waveguide 102 and the radiating elements. Thereby, each of the independently controllable phase shifter elements may be configured to change a phase of an electromagnetic wave present at the respective coupling point of the waveguide 102.

Alternatively, the controllable elements 104_1 to 104_n can comprise a tunable material. In this case, a degree of coupling of an electromagnetic wave (having a given phase) present at the respective coupling point of the waveguide 102 to the respective radiating element 106_1 to 106_m can be adjusted via (or by means of) the tunable material. The tunable material can be, for example, a tunable dielectric material, including liquid crystal material or ferroelectric material, or magnetically tunable ferrimagnetic or ferromagnetic material, or semiconducting materials, including pin diodes, varactor diodes.

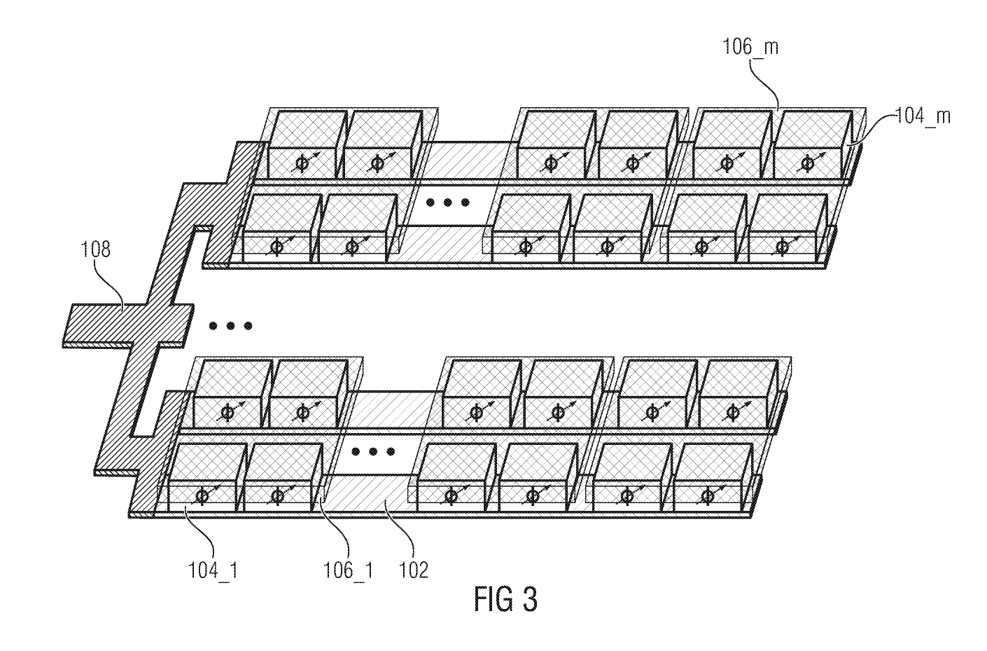

FIG. 3 shows an illustrative, perspective view of a phased array antenna 100 according to an embodiment. As already described with regard to FIG. 2, the phased array antenna 100 comprises a feed structure 102, a plurality of controllable elements 104_1 to 104_n and a plurality of radiating elements 106_1 to 106_m. Further, the phased array antenna 100 may comprise a splitter/combiner network 108 for a transmit/receive signal.

As shown in FIG. 3, the radiating elements 106_1 to 106_m cover and couple to one or multiple of the steerable elements 104_1 to 104_n. This is done for the purpose of defining the geometrical source location (defined by the location and geometry of the radiating element 106_1 to 106_m) of each radiated wave independently of the location of the steerable element(s) connected to the radiating element. By doing so, the original problem of finding a suitable phase (and optional amplitude) setting for each steerable element at the location of this steerable (and radiating) element transforms into the problem of finding a suitable effective phase (and optional amplitude) setting for each group of steerable elements. Embodiments provides additional flexibility with regard to the placement of the radiating elements and thus the location of each radiated wave.

Besides de-coupling of the locations of the steerable and radiating element, embodiments allow variation in the number of steerable elements 104_1 to 104_n connected to each radiating element 106_1 to 106_m and the arrangement of the steerable elements 104_1 to 104_n along the wave-propagating (feed) structure 102. Each of these steerable elements may implement a phase shifter, i.e. variable delay. Moreover, depending on the location of the steerable elements relative to the propagating wave, “early” or “late” versions of the propagating wave may be coupled into the radiating element. This provides a second degree of freedom in controlling the phase (and optional amplitude) of each radiated wave, as “early” or “late” versions of the propagating wave represent different phase-shifted versions of the same signal.

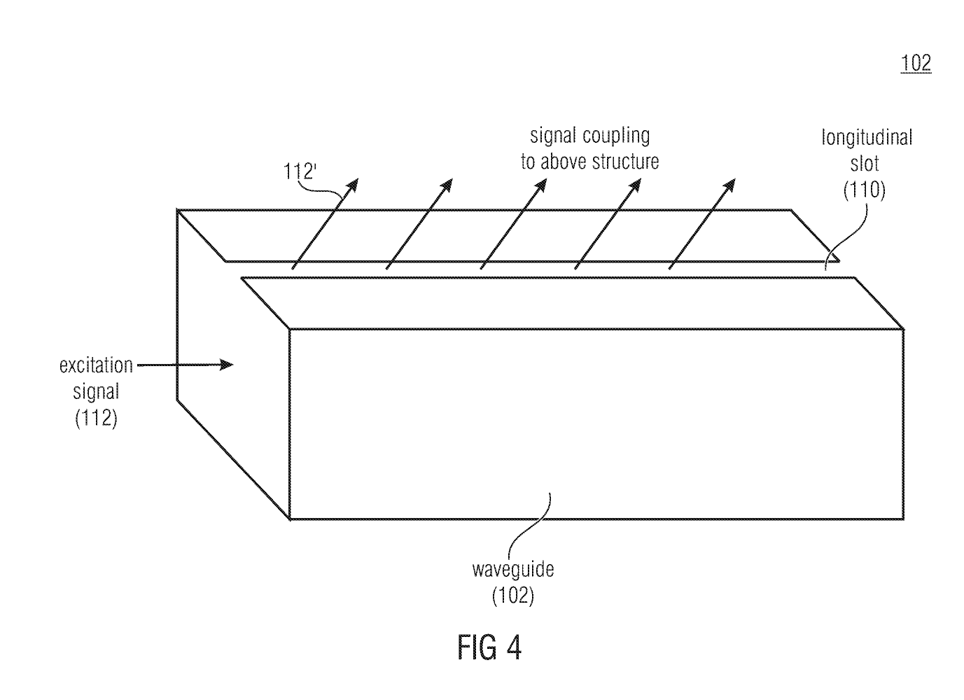

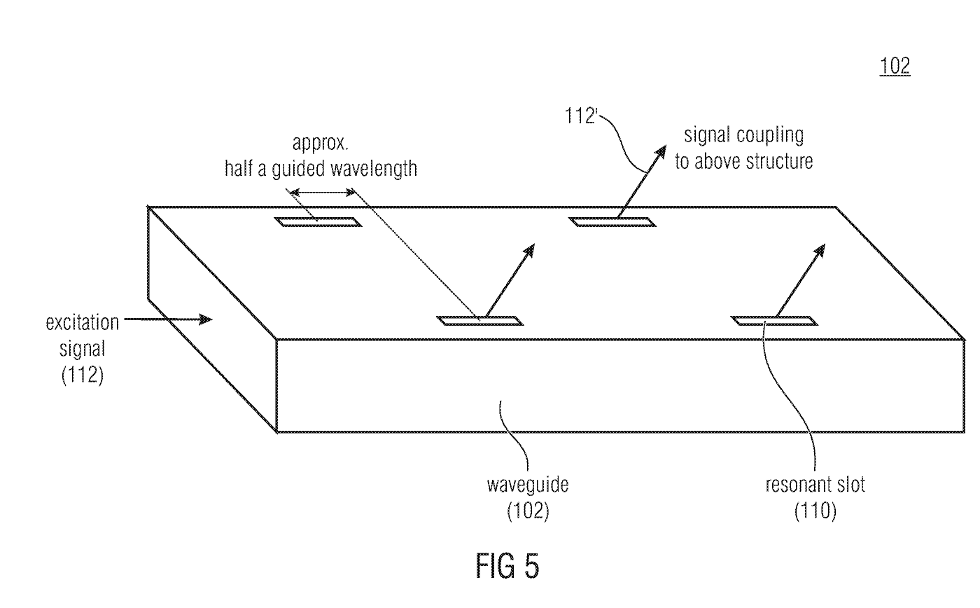

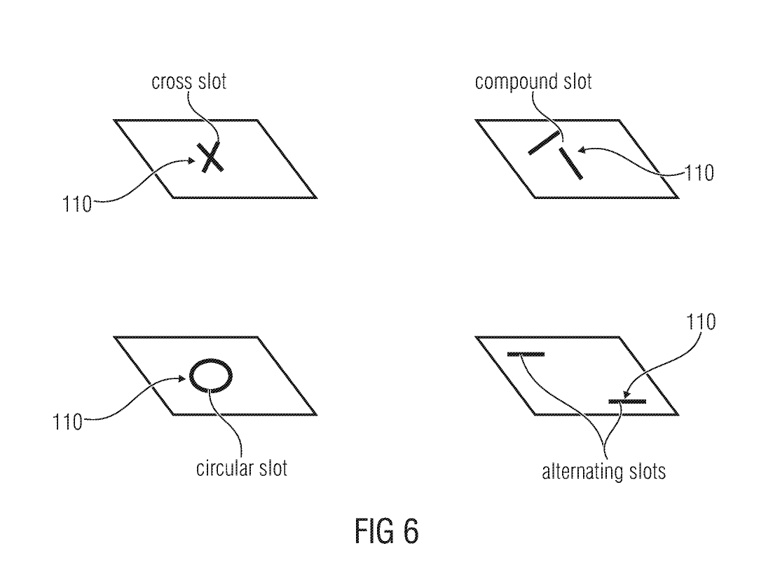

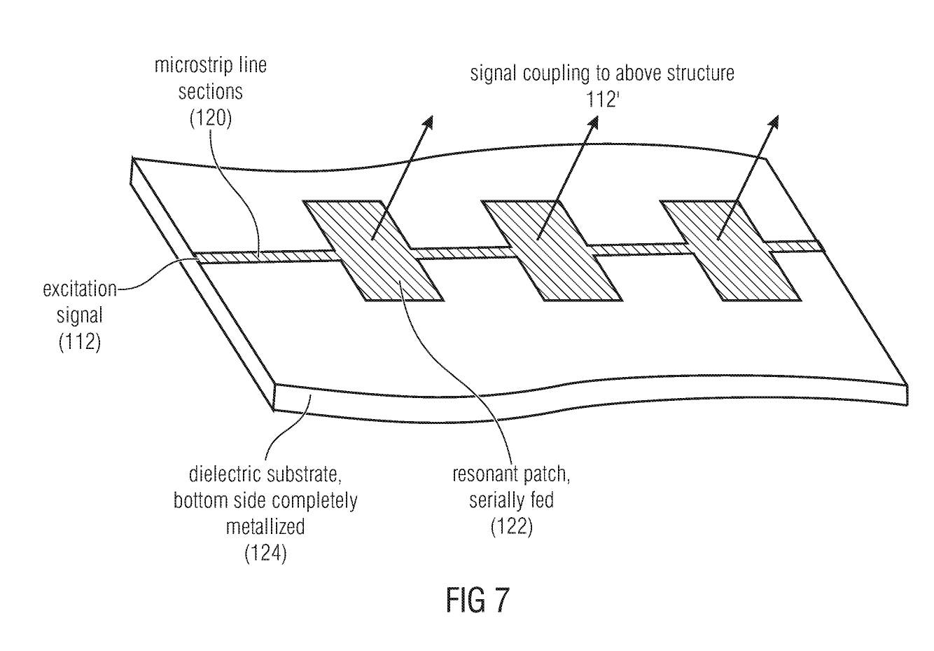

The coupling structure can be implemented in different ways. Each leaky-wave structure or each structure supporting waves that can be considered leaky waves can serve as feed structure 102. This includes, but is not restricted to, slotted waveguides with a longitudinal slot (cf. FIG. 4), slotted waveguides with periodically or non-periodically repeated, alternating slots (cf. FIG. 5), slotted waveguides with periodically or non-periodically repeated slots of a certain shape (cf. FIG. 6), microstrip-type periodically or non-periodically loaded transmission lines (cf. FIG. 7), among others.

In detail, FIG. 4 shows an illustrative, perspective view of an implementation of the feed structure 102 as waveguide with an aperture 110. The aperture (coupling point) is adapted to couple out a portion 112′ of the electromagnetic wave (e.g., excitation signal) 112 guided by the waveguide. In FIG. 4, the aperture is implemented as longitudinal slot. In other words, FIG. 4 shows a drawing of a slotted waveguide 102 with a longitudinal slot 110 aligned with propagation direction of the guided wave 112.

FIG. 5 shows an illustrative, perspective view of an implementation of the feed structure 102 as waveguide with a plurality of apertures 110. The plurality of apertures (coupling points) are adapted to couple out portions 112′ (having alternating phases) of the electromagnetic wave (e.g., excitation signal) 112 guided by the waveguide 102. As shown in FIG. 5, the plurality of apertures may be implemented as periodically repeated, alternating slots 110. Center points of the slots may be arranged at distances of half of the guided wavelength.

FIG. 6 shows an illustrative view of four different implementations of an aperture of the waveguide 102. As shown in FIG. 6, the aperture can be implemented as cross slot, compound slot, circular slot, or alternating slots. In other words, FIG. 6 shows drawings of possible slot geometries of slotted waveguides. Note that FIG. 6 shows an excerpt and that embodiments are not restricted to those geometries.

FIG. 7 shows an illustrative view of an implementation of the feed structure 102 as periodically loaded transmission line in microstrip technique. The feed structure 102 comprises microstrip line sections 120 and resonant patch sections 122 serially fed with an electromagnetic wave (e.g., excitation signal) 112 via the microstrip line sections 120. The feed structure 102 may further comprise a dielectric substrate 124 with a bottom side metallization (the bottom side may be completely metallized).

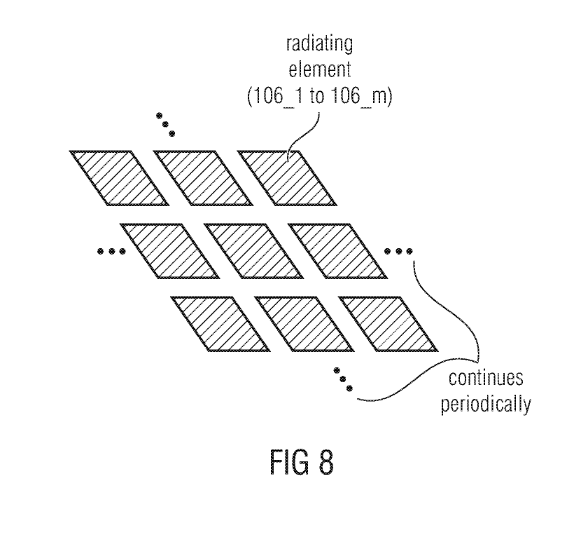

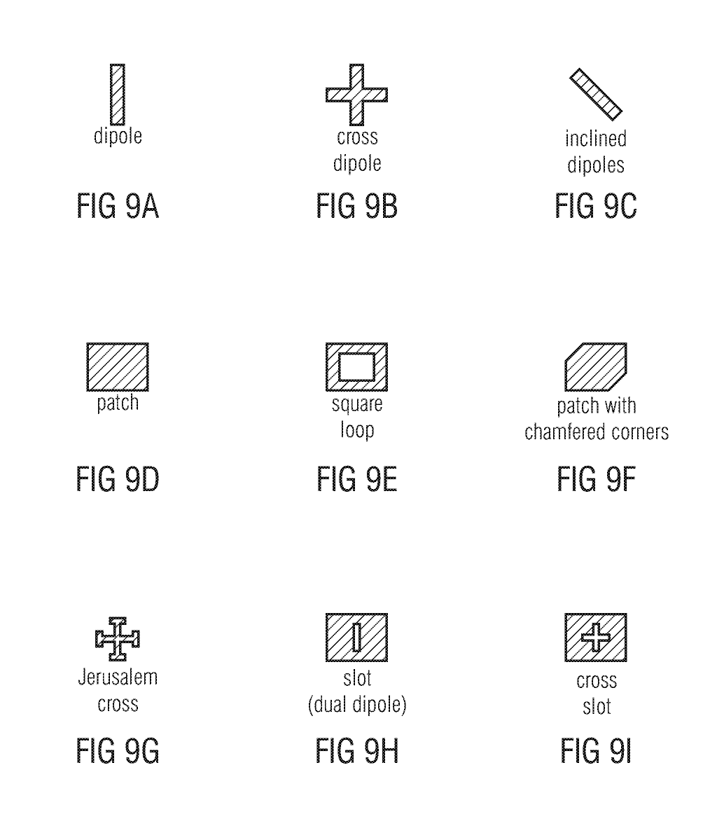

The radiating elements 106_1 to 106_m can be a two-dimensional arrangement of single radiators as portrayed in FIG. 8. A combination of two or more layers of such two-dimensional arrangements can be used. The elements can adopt different shapes. This includes, but is not restricted to, the shapes depicted in FIG. 9.

In detail, FIG. 8 shows an illustrative, perspective view of a two-dimensional arrangement of radiating elements 106_1 to 106_m. As can be gathered from FIG. 8, the radiating elements 106_1 to 106_m can comprise a planar shape. In other words, FIG. 8 shows a drawing of a two-dimensional arrangement of radiating elements building the radiating aperture.

FIG. 9a-9i show illustrative top-views of implementation examples for the radiating elements 106_1 to 106_m. In detail, the radiating elements 106_1 to 106_m can be dipoles (cf. FIG. 9a), cross dipoles (cf. FIG. 9b), inclined dipoles (cf. FIG. 9c), patches (cf. FIG. 9d), squared loops (cf. FIG. 9e), patches with chamfered corners (cf. FIG. 90, Jerusalem crosses (cf. FIG. 9g), slots (dual dipoles, cf. FIG. 9h) and/or cross slots (cf. FIG. 9i). In other words, FIG. 9a-9i show drawings of possible elements of the radiating aperture. Note that FIGS. 9a-9i show excerpts and that embodiments are not restricted to those geometries.

Although FIGS. 8 and 9a-9i show implementation examples where the radiating elements 106_1 to 106_m comprise a planar shape, the present invention is not limited to such embodiments. For example, the radiating elements 106_1 to 106_m may also be horn antennas (or microwave horns), wherein each of the horn antennas is coupled to at least two of the plurality of controllable elements 104_1 to 104_n.

Embodiments provide a number of advantages and improvements compared to known phased array architectures with respect to controlling the directivity (i.e. beam steering) of the phased array 100, for improving the gain of the phased array 100, and improved manufacturability. These advantages are primarily resulting from the option of (1) locating the radiating elements 106_1 to 106_m largely independently of the steerable elements 104_1 to 104_n, (2) adjusting the shape and geometry of the radiating elements 106_1 to 106_m, and (3) by having one or more additional layers (of radiating elements 106_1 to 106_m) in the construction of the phased array 100. These three advantages are described in further detail below.

First, the advantage of locating the radiating elements 106_1 to 106_m largely independently of the steerable elements 104_1 to 104_n is described.

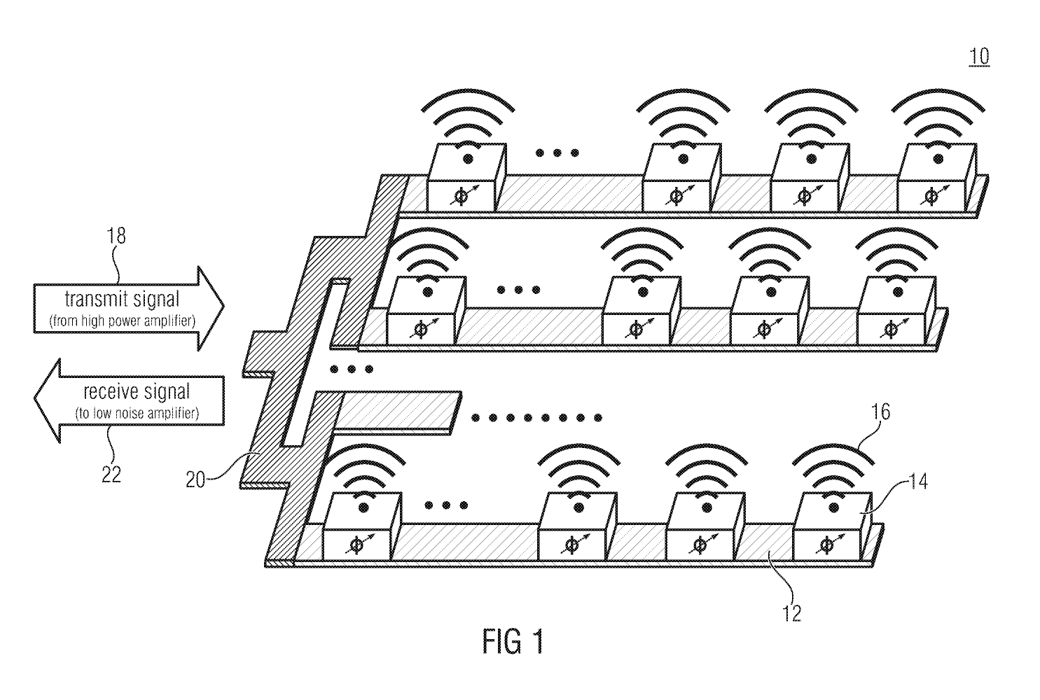

The two-dimensional problem of finding suitable phase (and optional amplitude) relation for the signal at each radiating element (or more precisely, steerable element (cf. FIG. 1)) and at the location of that radiating element translates into two independent problems of finding suitable phase (and optional amplitude) relation for the signal at each radiated element 106_1 to 106_m and independently placing the radiating elements.

When compared to WO 2012/050614 A1 that uses a large number of steerable and radiating elements that are arranged along a wave propagating structure at a distance smaller than the wavelength (less than λ/4 or λ/5). The speed of the propagating wave defines the relative phase at each given steerable element, and, as further described in WO 2012/050614 A1, the wanted radiation pattern (in far field) needs to be algorithmically translated into an e.g. “open” and “close” pattern for the steerable elements. As the location of the steerable elements is fixed (by construction), a suitable pattern for the steerable elements may not exist or may be sub-optimal, as the number and location of “open” steerable elements may conflict with the optimal phase relation at this location to optimally form the wanted radiation pattern (in far field) with maximum gain.

Further, the number of steerable elements coupling into any given radiating element 106_1 to 106_m may be varied along the direction of the propagating wave (i.e. along the wave-propagating or feed structure 102). As the delay of the signal increases from steerable element to steerable element along the direction of the propagating wave, different phase-shifted versions of the signal are available at each radiating element. The signal with the best matching phase relation may be selected and coupled into the radiating element by steering the corresponding steerable element “open” and steering all other steerable elements feeding into the same radiating element closed.

As a further variation, instead of just steering a radiating element open and all others closed, different weights can be applied, e.g. setting one element to 90% open and steering an adjacent element to 20% open, for the purpose of synthesizing signals with a phase between the two phases available at the respective steerable elements.

Each steerable element 104_1 to 104_n may be or include a phase shifter (e.g. based on liquid crystal material), that allows control over the propagation speed (and thus phase) of the wave through the steerable element. While the location of the steerable elements relative to the wave-propagating or feed structure 102 would already provide a coarse adjustment of the phase (e.g. four steerable elements, providing discrete phases of 0/4λ, ¼λ, 2/4λ and ¾λ), the additional phase shifter in the steerable elements would provide fine adjustment of the phase, having to cover only a range of ¼λ. As it is known that the thickness (and thus loss) of a phase shifter may scale with the to-be covered phase tuning range, this combination of coarse and fine phase steering allows use of lower to-be covered range fine phase shifters and therefore reduction of the losses in the fine phase shifter.

The steerable elements 104_1 to 104_n coupling into any given radiating element 106_1 to 106_m may also be placed perpendicular to the direction of the propagating wave. Different representation of the same signal would then be available at each steerable element (all with identical phase).

By using steerable elements 104_1 to 104_n that allow control of the signal propagation speed through the steerable elements (e.g. loaded lines with steerable loading, liquid crystal material with steerable permittivity (∈), ferrimagnetic or ferromagnetic material with steerable permeability (μ)), different phase versions of the same signal could be coupled into the respective radiating element 106_1 to 106_m by selecting one of the steerable elements 104_1 to 104_n.

As a further variation, the steerable elements 104_1 to 104_n may be operated in a binary fashion, e.g. switching between two (or more) well defined delays. In the example of a liquid crystal material with steerable permittivity (∈), these two well defined delays would e.g. be related to a parallel or perpendicular orientation of the crystals relative to the propagating wave. Using one delay setting in some of the steerable elements 104_1 to 104_n connected to the radiating element and a different delay setting in all other steerable elements 104_1 to 104_n connected to the radiating element allows synthesis of average phases between the two extreme states. As this synthesis is based on the number of steerable elements 104_1 to 104_n being operated in either one or the other delay mode, this variation allows, compared to steering each element directly to an intermediated delay using e.g. an analog control voltage, digital and reproducible control over the resulting phase. The setup is less susceptible to parameter variation (e.g. control voltage, elastic forces, and switching speed) as the steerable elements are driven into saturation.

Second, the advantage of adjusting the shape and geometry of the radiating elements 106_1 to 106_m is described.

Spacing and defining the size of the radiating elements 106_1 to 106_m independently of the steerable elements and the wave-propagating or feed structure 102 allows optimizing the size and spacing of the radiating elements 106_1 to 106_m as advised by the theory on phased arrays. The spacing and sizing of the radiating elements 106_1 to 106_m is not directly constrained by the spacing and size of the steerable elements 104_1 to 104_n. E.g. this allows use of phase shifter structures exceeding the size of the radiating element in a horizontal or stacked arrangement.

Further, by separating the steerable and radiating element, the gain and directivity of each radiating element may be individually optimized.

Moreover, by separating the steerable and radiating element, the pre-dominant inherent polarization characteristics of the radiating element may be individually selected and optimized. This allows e.g. building a phased array antenna with horizontal, vertical, left-hand circular or right-hand circular polarization characteristics of the individual radiating element. This provides additional flexibility over the known approach of defining the polarization indirectly, by using different strings of radiating elements and suitable combining of the signals electrically or electronically.

Third, the advantage of the additional layer (of radiating elements 106_1 to 106_m) in the construction of the phased array 100 is described.

The additional layer or stack of layers (e.g. of metalized radiating elements 106_1 to 106_m) provides cover and additional protection to the—now embedded—steerable elements 104_1 to 104_n. This may prevent or delay aging in the steerable elements 104_1 to 104_n, e.g. aging of liquid crystal material caused by exposure to sunlight.

Regarding manufacturability, and robustness against parameter variation and tolerances, separation of the radiating elements 106_1 to 106_m from the remaining parts of the phased array structure provides advantages, as the characteristics of the radiating elements 106_1 to 106_m is primarily defined by geometry. As further detailed above, there are options to digitally control the phase shifter, e.g. by switching between discrete states and synthesizing intermediate phase relations by combining such discrete states, using multiple steerable elements. Such an embodiment has the advantage of being less sensitive to parameter variation and manufacturing tolerances than an embodiment directly controlled by an analog signal.

Furthermore, the additional layer or stack of layers of radiating elements 106_1 to 106_m allows coupling to probe structures (embedded in the construction, e.g. under the radiating elements) without affecting, modifying or disturbing the radiation characteristic of the element. Such probe structures may connect to sensing or injecting signal lines, dedicated to each radiating element, to a group of elements or organized in a switch matrix arrangement. In transmit mode, such sensing allows monitoring of the actual phase relation at any given radiating element, and use of this information as control signal in a closed-loop phase control. In receive mode, such injecting signal lines allow e.g. the injection of a low-power and/or narrow-band test signal inside or outside the band of interest, reconstruction of the test signal after being transmitted through radiating element, steering elements, wave-propagating or feed structure 102 and low-noise amplifier. Again this reconstructed signal would allow monitoring the actual phase relation at any given radiating element, and use of this information as control signal in a closed-loop phase control.

Embodiments can be used in satellite communication, especially beam forming and tracking for moving receivers or transmitters.

Further, embodiments can be used in other communication systems (including mobile phones, wireless local area networks, etc.) that benefit from improved antenna gain and/or directivity.

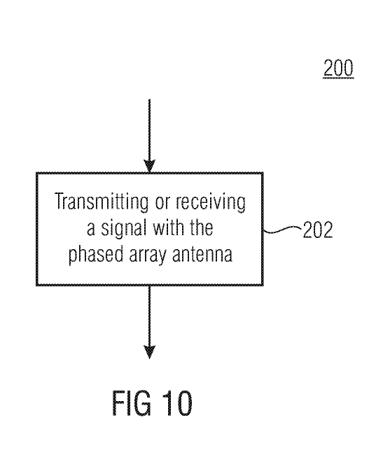

FIG. 10 shows a flowchart of a method 200 for operating a phased array antenna 100. The phased array antenna 100 comprises a feed structure 102 adapted to guide an electromagnetic wave 112, a plurality of controllable elements 104_1 to 104_n coupled to the feed structure 102, and a plurality of radiating elements 106_1 to 106_m, wherein each of the radiating elements 106_1 to 106_m is coupled to at least two of the plurality of controllable elements 104_1 to 104_n. The method comprises a step 202 of transmitting or receiving a signal with the phased array antenna 100.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Phased array antenna, comprising:
a feed structure adapted to guide an electromagnetic wave;
a plurality of controllable elements coupled to the feed structure; and
a plurality of radiating elements;
wherein each of the radiating elements is coupled to at least two of the plurality of controllable elements.

2. Phased array antenna according to claim 1, wherein the controllable elements are adapted to couple energy between the feed structure and the radiating elements.

3. Phased array antenna according to claim 1, wherein the radiating elements are fed at at least two different positions via the at least two controllable elements.

4. Phased array antenna according to claim 1, wherein at least two of the plurality of controllable elements are fed by the feed structure at different positions.

5. Phased array antenna according to claim 1, wherein each of the radiating elements is resonantly coupled to at least two of the plurality of controllable elements.

6. Phased array antenna according to claim 1, wherein each of the at least two controllable elements is adapted to individually adjust its degree of coupling to the respective radiating element.

7. Phased array antenna according to claim 1, wherein the feed structure comprises a waveguide.

8. Phased array antenna according to claim 7, wherein the controllable elements comprise independently controllable phase shifter elements arranged between coupling points of the waveguide and the radiating elements.

9. Phased array antenna according to claim 8, wherein the phase shifter elements comprise a tunable material.

10. Phased array antenna according to claim 7, wherein the waveguide comprises a plurality of apertures as coupling points.

11. Phased array antenna according to claim 1, wherein the radiating elements comprise a planar shape.

12. Phased array antenna according to claim 1, wherein the radiating elements are dipoles, cross dipoles, patches, slotted patches or squared loops.

13. Phased array antenna according to claim 1, wherein the feed structure, the plurality of controllable elements and the radiating elements form stacked layers.

14. Method for operating a phased array antenna, the phased array antenna comprising a feed structure adapted to guide an electromagnetic wave, a plurality of controllable elements coupled to the feed structure, and a plurality of radiating elements, wherein each of the radiating elements is coupled to at least two of the plurality of controllable elements, the method comprising:
transmitting or receiving a signal with the phased array antenna.

15. Method for operating a phased array antenna according to claim 14, further comprising:
varying the controllable elements for adjusting a directional characteristic of the phased array antenna.
